(19) United States
(12) Patent Application Publication
(10) Pub. No.: US 2008/0312988 A1
(43) Pub. Date: Dec. 18, 2008

(54) Performance rating of a business

(75) Inventors: Steven Trapp, Fort Worth, MN (US); Michael Sillay, Alpharetta, GA (US); David Knapp, Lake Forest, CA (US)

Correspondence Address: AKZO NOBEL INC., LEGAL & IP, 120 WHITE PLAINS ROAD, SUITE 300, TARRYTOWN, NY, 10591, US

(73) Assignee: AKZO NOBEL COATINGS INTERNATIONAL B.V., Arnhem (NL)

(21) Appl. No.: 11/818,459

(22) Filed: Jun. 14, 2007

(51) Int. Cl. G06F 17/00

(52) U.S. Cl. 705/7

(57) ABSTRACT

Method for performance rating of a business entity using a server computer and one or more remote client computers linked to the server computer by a communication network, the method including defining performance metrics related to performance of the business entity; defining desired weighting for each metric; obtaining performance data for the business entity for each metric; defining a rating scale for each metric, wherein the rating scale for at least one performance metric is determined based on statistical data derived from a plurality of comparative business entities; comparing the performance data for the business entity to the rating scale for each metric; and deducing a performance rating for the business entity on the basis of the comparison between the performance data and the rating scale, and the desired weighting, for each metric.

### FIELD OF THE INVENTION

The present invention relates to a method for performance rating of a business entity using a server computer and one or more remote client computers linked to the server computer by a communication network.

### BACKGROUND OF THE INVENTION

WO 00/68861 discloses an Internet based system for evaluating performance of a financial services organization, which includes benchmarking the evaluated company against its peers. This system purportedly allows benchmarking for other types of businesses. It discloses that, if so desired, a user can benchmark against similar businesses, e.g., companies which are active in the same field. However, the disclosed system does not provide an overall performance rating for the business that is tailored to specific users of the system.

Although there are other benchmarking systems known in the art which allow benchmarking against similar companies, they typically focus on very specific markets and are limited to comparison of specific performance areas and/or to general standards. An example of such a specific system is disclosed in international patent application WO 02/01453. This system is specifically designed for the vehicle repair business. This program enables a user to compare its performance in specific performance categories to general standards. A problem with such a system is that the standards may not be equally suitable for all users and may become outdated within a short time. Moreover, the system does not provide an overall performance rating that is tailored to specific users of the system.

Collision repair shops for refinishing damaged cars, generally referred to as body shops, can differ considerably in size, in the types or numbers of cars they refinish, in the quality standards they wish to maintain, etc. Moreover, their performance is dependent on seasonal influences: in winter more car accidents occur than in summer. Comparing a car repair body shop with a general standard of performance therefore does not result in an accurate analysis. Moreover, performance criteria for a body shop will be different depending on the evaluator's interests. For example, an insurance carrier will likely rate a body shop using different criteria than will a consumer who is paying for the repair out of pocket. Therefore, there is a need for a system that can evaluate collision repair shops, or other businesses, that provides an accurate rating of the business and that can be tailored to the interests of the customer(s) evaluating the business.

### SUMMARY OF THE INVENTION

The object of the invention is to find a system for performance rating of a business which results in a more accurate analysis and can be tailored to the interests of the customer evaluating the business entity.

The object of the invention is achieved with a method for performance rating of a business entity using a server computer and one or more remote client computers linked to the server computer by a communication network, the method including:
(a) defining a plurality of performance metrics related to performance of said business entity;
(b) defining desired weighting for each performance metric of the plurality of performance metrics;
(c) obtaining performance data for said business entity for each performance metric of the plurality of performance metrics;
(d) defining a rating scale for each performance metric, wherein the rating scale for at least one performance metric is determined based on statistical data derived from a plurality of comparative business entities for said at least one performance metric;
(e) comparing said performance data for said business entity to said rating scale for each performance metric; and
(f) deducing a performance rating for said business entity on the basis of the comparison between said performance data from said business entity and said rating scale, and said desired weighting, for each performance metric.

In one embodiment, the step (f) of deducing the performance rating includes the steps:
(g) determining an unweighted metric rating for each performance metric on the basis of the comparison between said performance data from said business entity and said rating scale for each performance metric;
(h) calculating a weighted score for each performance metric on the basis of said desired weighting and said unweighted metric rating; and
(i) calculating said performance rating for said business entity on the basis of all weighted scores.

Preferably, the business entity is a service business entity. Preferably, the service business entity is a collision repair shop. In such a case, the performance metrics are preferably at least two metrics selected from the group consisting of weighted repair severity, percent supplemented, number of supplements, ratio of parts as percentage of sales, alternative parts percentage, ratio of repairs to replacements, PCI (percent of estimates passing chosen insurer's audit profile), reinspection results, closed claim compliance, CSI (consumer survey information), days late, severity weighted cycle time, repair quality index, CIC “Class A” criteria qualification and manufacturer approved repair.

Also, in such a case, the client can be selected from the group consisting of the business entity, another collision repair shop, consumer, insurance agent, insurance claims personnel, auto dealership, fleet administrator and other stakeholder involved in the collision repair process.

### BRIEF DESCRIPTION OF THE DRAWINGS

FIG. 1: Flow diagram of an exemplary network system for performance rating of a collision repair shop.

FIG. 2: An example of a graphical user interface displaying the performance rating screen for a selected collision repair shop.

FIGS. 3a & 3b: A chart showing an example of how the rating scale is determined for various metrics for performance rating of a collision repair shop.

### DETAILED DESCRIPTION OF THE INVENTION

The system and method according to the present invention enables a collision repair shop to customize and fine-tune its performance rating analysis and to compare its performance with those of body shops in the same country or region, over the same period or in the same sub-market, or with those of body shops of similar size, number of employees, etc., using an objective and comprehensive rating system. The ability to define desired weighting for each metric used to evaluate performance allows for a customized evaluation tailored to the interests of the user of the system. In one embodiment, it is contemplated that a user can interactively define its/their own performance rating criteria by inputting desired weighting for each metric. The data for each metric, on which the repair shop is evaluated, is preferably updated periodically. If the body shop is part of a chain, e.g., a franchise chain, it can compare its performance with those of other franchisees or a relevant group among the franchisees.

In addition to body shops evaluating and comparing their own performance, the system and method are useful for others associated with or affected by the collision repair industry to make objective, informed decisions regarding future usage of participating repair shops, such as a consumer with a damaged vehicle, insurance agents, insurance claims personnel, auto dealerships, fleet administrators and other stakeholders involved in the collision repair process.

The metrics used to evaluate repair shop performance are preferably related to or driven by the “7c's” of collision repair, namely Consistency of the repair process, Cost containment, Cycle time minimization, Customer satisfaction, Convenience, Connectivity and Coverage.

Examples of metrics driven by such concerns include the following performance metrics: weighted repair severity, percent supplemented, number of supplements, ratio of parts as percentage of sales, alternative parts percentage, ratio of repairs to replacements, PCI (percent of estimates passing chosen insurer's audit profile), reinspection results, closed claim compliance, CSI (consumer survey information), days late, severity weighted cycle time, repair quality index, CIC “Class A” criteria qualification and manufacturer approved repair. This list is not exhaustive and other metrics can be added to the defined group of metrics used to evaluate the performance of the collision repair shop.

Weighted repair severity refers to a weighted average cost for all repairs during a given cycle, e.g. a monthly cycle. The weighted average cost can be determined based on the individual average cost for a repair at each severity level adjusted by a weight factor, where the severity level is determined by estimated labor hours for the repair. The weighted repair severity is the sum of the weighted cost at each severity level. An example of weighted repair severity for a given collision repair shop is shown below in Table 1.

TABLE 1
Total Weighted Severity Example

| | | | Average | |
|---|---|---|---|---|
| | | | Repair Value | |
| | | | for the | |
| | Actual Total Labor | | category (12 | |
| | Hours written on the | *Severity | Month Rolling | Weighted |
| Category | Shops Estimate | Weighting | Average) | Severity |
| 1 | 0-5 | 10% | $320 | $32.00 |
| 2 | 5.1 to 10 | 10% | $670 | $67.00 |
| 3 | 10.1 to 15 | 10% | $995 | $99.50 |
| 4 | 15.1 to 20 | 10% | $1,343 | $134.30 |
| 5 | 20.1 to 25 | 10% | $1,705 | $170.05 |
| 6 | 25.1 to 30 | 10% | $2,423 | $242.30 |
| 7 | 30.1 to 35 | 10% | $2,905 | $290.50 |
| 8 | 35.1 to 40 | 10% | $3,508 | $350.80 |
| 9 | Over 40 | 20% | $4,627 | $925.40 |
| | Total Weighted | 100% | | $2,311.85 |
| | Severity | | | |

*The severity weighting is predetermined for each severity level.

Percent supplemented means percent of supplements generated during a given period, e.g. one month. Supplements are documents created by the collision repair shop when a change or addition must be made to an insurance approved estimate. It is also sometimes referred to as a supplemental estimate.

Number of supplements means average number of supplements per repair, calculated on a periodic basis, e.g., monthly basis.

Ratio of parts as percentage of sales means parts sales as percentage of total facility sales measured on a periodic basis, e.g., one month.

Alternative parts percentage means alternative parts sales as a percentage of total parts sales measured periodically (e.g. monthly). Alternative parts refers to the category of parts which includes salvaged, recycled and aftermarket parts.

Ratio of repairs to replacements means the percentage of repair labor time dedicated to repairing, as compared to replacing parts.

PCI (or estimating compliance) means percentage of estimates that pass the chosen insurer's audit profile.

Reinspection results refers to scores given to vehicles that have been inspected after the repairs are complete. The score reflects compliance of the actual repairs done to the closed claim file. The closed claim file is the repair reflected in the final bill where payment has been made.

Closed claim compliance means percentage of claims that pass the business rules for the insurer of record on a closed claim file.

CSI (or consumer survey information) refers to the average third party score (or percentage) over a given period, e.g., one month, for an affirmative answer to the following question: “would you refer or re-use” the repair shop?

Days late means the average number of days late for all repair jobs during a given period, e.g., one month.

Severity weighted cycle time means the cycle time for a repair weighted for the severity of the repair based on units/hour per repair.

Repair quality index refers to a (1-10) score given to the repairer after inspecting in-process and completed vehicles. This is preferably a service provided by a third party who audits the repairs against technical industry repair standards.

CIC “Class A” criteria qualification refers to a third party measure of the frequency the repair shop meets its weighted criteria. The weighted criteria includes the requirements required to be recognized as a “Class A” collision repair center by the Collision Industry Conference. The Collision Industry Conference Definitions Committee identified the following requirements for a collision repair center to be recognized as a “Class A” collision center in the industry:
1) Have an established business location that is in compliance with local zoning laws and acceptable retail standards.
2) Have all local, state, and federal licenses and permits and operate in accordance with regulations.
   Examples:
      a. Sales Tax ID Number
      b. Federal Tax ID Number
      c. Fire, Electrical Code, and Waste Water Codes
      d. Workers' Compensation Insurance
      e. Meet or exceed all federal/state/local safety and environmental standards
      f. EPA Number
3) Have proof of garage keeper's liability and workers' compensation insurance or equivalent.
4) Have the ability to produce computer generated estimates with digital imaging and electronic estimate transfer.
5) Management personnel will have evidence of current and ongoing training in relevant management subjects and have transcripts or certificates.
6) Belong to and participate in auto collision trade industry association(s) and subscribe to the Collision Industry Conference (CIC) “Best Practices.”
7) Have evidence of current and ongoing employee technical training and certification programs with a certified refinish technician on staff.
8) Have a gas metal arc (GMA/MIG) welder and technicians qualified or certified in proper welding techniques.**
9) Have the ability to hoist a vehicle for inspection.
10) Subscribe to a provider of structural specifications with periodic updates covering the vehicle structure for the make, model and year of the vehicle(s) being repaired and wheel alignment specifications for the make, model and year of the vehicle(s) being repaired.
11) Have a measuring device capable of measuring in three dimensions (symmetrical or asymmetrical unibody and full frame structures) for the type of vehicle repaired and provide structural documentation such as a computer printout, or have a fixture system. All operators must have evidence of current training available for viewing for the type of measuring device being used.
12) Have a four-point anchoring system capable of holding a vehicle in a stationary position during frame and/or unibody pulls which is suitable for the specific type of vehicle being repaired.
13) Have electrical or hydraulic equipment capable of making simultaneous multiple body or structural pulls. All operators must have evidence of current technical training on the type of equipment being used.**
14) Have pressurized spray booth equipped with a fresh air-supplied respirator system that meets current federal, state and local requirements.
15) Have the ability to complete and verify four-wheel alignment through computer printout either from an in-house alignment system with at least one technician that is certified or qualified or utilize a qualified sublet provider.**
16) Offer a written limited lifetime warranty against defects in workmanship.
17) Have the ability to remove and reinstall frame, suspension, engine and drive train components.
18) Have a forced drying and curing paint application system that will produce an original equipment manufacturer-type finish.
19) Demonstrate a concern for the environment by using high transfer efficiency spray equipment, gun cleaners and other emission reducing equipment.
20) Properly dispose spray booth filters and hazardous waste.
21) Provide proper safety equipment and work environment for all employees.
22) Have employees that are qualified to diagnose the condition of airbags and other occupant restraint systems and capable of completing OE-specified repairs using in-house equipment with certified technicians or use a qualified sublet provider with certified technicians.
23) Have the ability to evacuate, reclaim and recharge vehicles air conditioning system using EPA compliant in-house equipment and certified technicians or use a qualified sublet provider.**
24) Have a documented on-going system for measuring, tracking and reporting customer satisfaction. ** Certified and qualified can include CIC accepted certification or qualification programs.

Manufacturer approved refers to third party verification that the repairer has been approved by that brand's manufacturer to repair the vehicle.

Once performance metrics for evaluating the business are defined, a desired weighting is defined for each performance metric. The desired weighting can be the same or different for each metric. The desired weighting is preferably different for different metrics, to reflect the importance of each respective metric relative to each other. Preferably, the desired weighting will be entered as a number representing a percentage of the total desired weighting for all metrics. In such a case, the sum of all desired weightings will total 100. For example, if there are three metrics (metrics A, B and C) and the user enters 60 for A, 20 for B and 20 for C, they total 100 and A will be weighted heavier, i.e., it will be considered more important than B or C. If a metric is assigned a desired weighting of 0, that metric will not be considered in evaluating performance of the repair shop. In an embodiment where a user is permitted to input the desired weighting, the user interface can be programmed to require the desired weightings entered by the user (and to prompt the user) to total 100.

A rating scale is defined for each performance metric to allow for measurement of the performance data collected from the collision repair shop being rated. Preferably, the rating scale is a graduated scale ranging from 1 to 10 proportionate with a range of values for each metric, with 1 corresponding to the least desired value in the range of values and 10 corresponding to the most desired value in the range of values.

Preferably, a database of performance data, obtained from a number of comparative repair shops (to the repair shop being evaluated) and/or from third party verifiers that collect (and/or verify) the performance data, can be used for determining a rating scale for each metric. The rating scale can be updated periodically, as the performance data being collected changes and/or as additional data is collected. Comparative repair shops can be selected based on predetermined or selectable criteria, for example geographic location, shop size or number of employees. The comparative repair shop data can also include performance data from the repair shop being evaluated.

In a preferred embodiment, the range of values used in connection with the rating scale for each metric is based on statistical analysis of the performance data obtained from the comparative repair shops. In one embodiment, typically where the performance data resembles a normal (or Gaussian) distribution, the values corresponding to 1 and 10 can be functions of the standard deviation of the collected performance data (from the comparative repair shops). Preferably, in such a case, the values for 1 and 10 correspond to an amount equal to a multiple of the standard deviation away from the median or mean. For example, 1 on the rating scale can correspond to a value 2 standard deviations below the median value (i.e., in the direction less favorable than the median value) and 10 on the rating scale can correspond to a value one standard deviation above the median value (i.e., in the direction more favorable than the median value). The high and low values can also be a function of the average (or mean), instead of the median.

In another embodiment, typically where the performance data does not resemble a normal (or Gaussian) distribution, the values corresponding to 1 and 10 can be functions of a percentage difference from collected performance data points, e.g., the endpoints, or from the median, average or mean of the collected data. For example, 1 on the rating scale can correspond to a value 10% above the lowest value (i.e., 10% in the direction more favorable than the worst case value recorded) and 10 on the rating scale can correspond to a value 10% below the highest value (i.e., 10% in the direction less favorable than the best case value recorded). In yet another embodiment, the values corresponding to 1 and 10 can be functions of a percentage of the collected performance data population. For example, the values for the highest and lowest 10% of the data population, based on the total number of repair shops, can be disregarded and the values corresponding to 1 and 10 can be the lowest and highest values of the remaining data population.

In another embodiment, typically where the performance data resembles a normal (or Gaussian) distribution on one side of the median (or mean or average) and does not resemble a normal (or Gaussian) distribution on the other side of the median (or mean or average), a combination of the embodiments for determining the values corresponding to 1 and 10, as discussed above, can be used. For example, if the performance data on the side less favorable than the median resembles a normal distribution and the data on the side more favorable than the median does not resemble a normal distribution, than 1 on the rating scale can correspond to a value 2 standard deviations below the median value (i.e., in the direction less favorable than the median value) and 10 on the rating scale can be determined by disregarding the values for the highest (i.e., most favorable) 10% of the data population, based on the total number of repair shops, and setting the value corresponding to 10 at the highest value of the remaining data population.

It should be understood that, regardless of how the values corresponding to 1 and 10 are calculated or determined, outlying, extraneous or extrinsic data points from the collected performance data can be excluded prior to performing such calculations or determinations. A system administrator can also periodically make manual adjustments to individual metric rating scale ranges based on analysis of composite business performance data.

The values for 1 and 10 can also be set at an actual performance minimum or maximum limit, respectively, where applicable, when the calculated values fall outside such limits. For example, if the calculated value for 1 on the rating scale for Closed Claim Compliance (based on a function of standard deviation) is below 0%, the value for 1 will be set at 0% because it is not possible to have less than 0% compliance. The graduations (2-9 on the scale) can be evenly divided between the values corresponding to 1 and 10 on the scale.

In one embodiment, the median (or mean) can be set to correspond to a specific number on the scale, e.g. 6, and 1 and 10 can be determined, as discussed above. In such an embodiment, the graduations 7-9 can be evenly divided between the values for 6 and 10 and the graduations 2-5 can be evenly divided between the values for 1 and 6.

Performance data for each metric can be obtained from the repair shop being evaluated, and/or from third party verifiers that collect and/or verify data from the subject repair shop, and stored in a database. This database can be updated periodically, preferably monthly, more preferably weekly and, most preferably, daily. The performance data is preferably compared to the rating scale for each metric to determine an unweighted metric rating for the subject repair shop for each metric.

A weighted score for each metric is then preferably determined from the unweighted metric rating and the desired weighting. Preferably, the weighted score is determined by multiplying the unweighted metric rating by the desired weighting and dividing by 10 (to adjust for percentage based numbers). For example, if the rating scale is from 1 to 10, 1 being the least desired and 10 being the most desired, and the unweighted metric rating for the given metric type is 6, and the desired weighting for that metric is 20 (based on a percentage of total desired weighting), then the weighted score for that metric type is 12 (or 60% of 20). In the same example, if the unweighted metric rating is 10 instead of 6, the weighted score is 20 (or 100% of 20).

The performance rating is preferably the sum total of the weighted scores for all metrics. In the example above, where the rating scale is from 1 to 10 and the desired weight for each metric is a percentage of all desired weighting, the maximum obtainable performance rating is 100. In one embodiment, the performance rating can be expressed as an overall rating level based on the maximum obtainable performance rating.

In one preferred embodiment, the business entity being evaluated is first certified before receiving a performance rating. To be certified, the business entity needs to satisfy the criteria for each of one or more certifications. Satisfying the criteria for a given certification can involve obtaining performance data for the business entity for one or more performance metrics. Preferably, satisfying the criteria for each of the certifications (required for the business entity to be certified) includes obtaining performance data for all of the performance metrics used to determine a performance rating. Prior to satisfying the criteria for each of the certifications (required for the business entity to be certified), the business entity can receive a certification rating based on the number of certifications in which the certification criteria has been satisfied.

Each certification can be based on different categories of performance metrics. For a collision repair shop, the certifications preferably include at least two certifications directed to different categories of metrics selected from the group consisting of a Refinish Certification, CIC Class A Collision Center Certification, Repair Quality Certification, Customer Satisfaction Indexing Certification and Estimates and Repair Status Certification. Refinish Certification means the shop employs a painter certified by the paint manufacturer and participates in the manufacturer's product assurance plan. CIC Class A Collision Center Certification means the shop has been audited by a third party against the criteria for CIC “Class A” certification. Repair Quality Certification means the shop participates in a program for onsite quality inspections of in-process vehicles. Customer Satisfaction Indexing Certification means the shop participates in a third party program that collects customer satisfaction information. Estimates and Repair Status Certification means the shop participates in a third party program that collects data for various metrics related to repair estimating and status information. In one embodiment of the invention, the repair shop will receive a certification rating based on the number of certifications that it has achieved. For example, the certification rating can be represented by “stars,” where the shop will be five star rated by complying with all five certifications. Preferably, once a collision repair shop receives a five star rating it will signify that all the necessary data is being collected to receive a performance rating, as discussed above.

The results of the performance analysis can for instance be reported by graphical output or cell data output which can be readily imported into the usual spreadsheet software, such as Excel® of Microsoft.

The communication network can for instance be the Internet. Alternatively, the communication network can be an extranet or an intranet. It is preferred to use web technology to design the user interfaces of the system to optimize ease of use. Web technology can be used for implementation, allowing the user to use browser software, such as Internet Explorer® of Microsoft or Netscape's Navigator®, as a basis for the user interface of the system.

Since confidential information may be communicated by the users, the information is preferably protected by password authentication, firewall technology and/or 128-bit encryption.

The present invention is also directed to a computer implemented system for performance rating of a business entity, including: a processor for receiving and transmitting data; and a memory coupled to the processor, the memory having stored therein sequences of instructions which, when executed by the processor, cause the processor to perform the steps of: defining a plurality of performance metrics related to performance of the business entity; defining desired weighting for each performance metric of the plurality of performance metrics; obtaining performance data for the business entity for each performance metric of the plurality of performance metrics; defining a rating scale for each performance metric, wherein the rating scale for at least one performance metric is determined based on statistical data derived from a plurality of comparative business entities for the at least one performance metric; comparing the performance data for the business entity to the rating scale for each performance metric; and deducing a performance rating for the business entity on the basis of the comparison between the performance data from the business entity and the rating scale, and the desired weighting, for each performance metric.

The present invention also involves a computer-readable medium whose contents cause a computer system to determine a performance rating of a business entity by performing the steps of: defining a plurality of performance metrics related to performance of the business entity; defining desired weighting for each performance metric of the plurality of performance metrics; obtaining performance data for the business entity for each performance metric of the plurality of performance metrics; defining a rating scale for each performance metric, wherein the rating scale for at least one performance metric is determined based on statistical data derived from a plurality of comparative business entities for the at least one performance metric; comparing the performance data for the business entity to the rating scale for each performance metric; and deducing a performance rating for the business entity on the basis of the comparison between the performance data from the business entity and the rating scale, and the desired weighting, for each performance metric.

The sequence of instructions or contents of the computer-readable medium can include a computer program that can be in any suitable programming language, but languages particularly suitable for web application, such as Java, are preferred.

The computer-readable medium can include a data carrier, such as a CD ROM, a hard disk, a tape or any further suitable medium for memory storage.

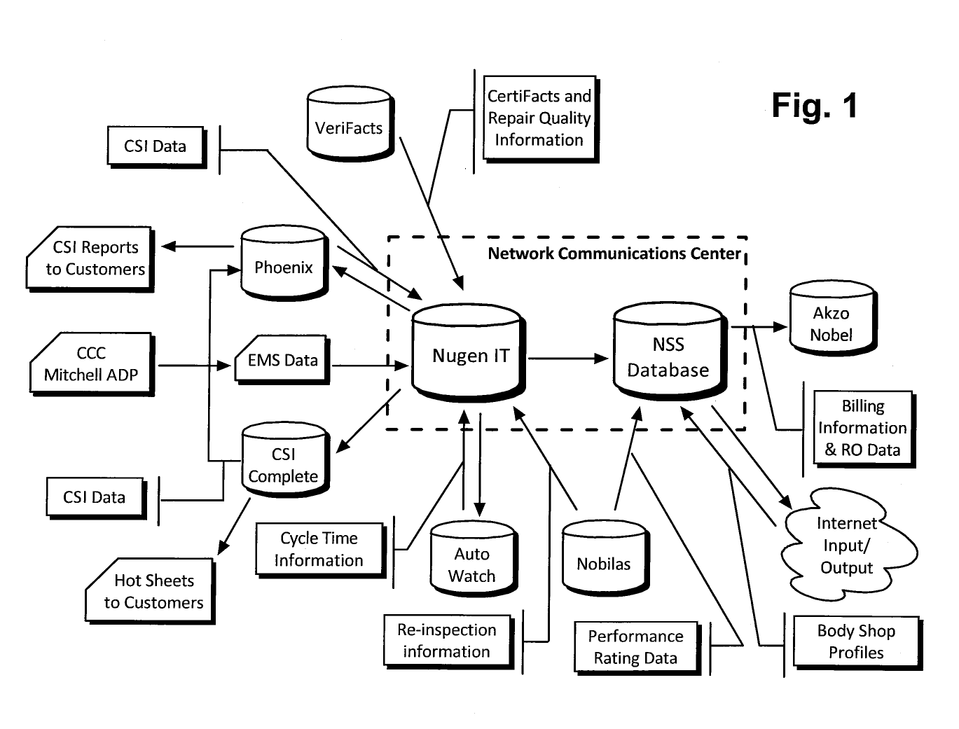

The invention is further described and illustrated by the drawings. In the drawings, FIG. 1 shows a flow diagram of an exemplary network system for performance rating of a collision repair shop showing infrastructure and data flow for the network. FIG. 1 shows that the network communications center receives data from third party verifiers, as well as from internet input from body shops and users.

The third party verifiers include VeriFacts which collects and provides CertiFacts and repair quality information used to determine the following metrics: Repair Quality Index, CIC Class A compliance and Auto Manufacturer Certification verification. CertiFacts is a brand name of VeriFacts for the service that collects the data and performs the verifications. The three metrics are verified by VeriFacts through onsite visits of VeriFacts' auditors. The auditors examine in process vehicles, audit repair files and collect and certify documents attesting to compliance with the CIC Class A criteria and OEM Program Certifications. The Auditors will preferably visit the shops 5 times in the first year and quarterly in years after.

Phoenix Solutions Group Located in Hoffman Estates, III and CSi Complete located in Columbus Ohio collect and provide CSi survey data used to determine the CSI metric. Phoenix provides a “mailed” survey option and CSi Complete offers “voice” surveys. The survey questions are standardized and are 15 questions long. Phoenix also provides CSi Reports of the survey results to its customers. CSi Complete also provides Hot Sheets to its customers. Hotsheets are concerns/complaints that customers have that are uncovered during the Satisfaction survey process. The hot sheets are sent to the Repairer for resolution.

AutoWatch provides an online vehicle status service which enables consumers to view digital photographs of their vehicles via the internet. Through integration with the AutoWatch system, cycle time information is collected to determine the weighted cycle time metric.

Nobilas is a wholly owned subsidiary of Akzo Nobel NV and is in the business of providing claims and fleet management services to insurance companies and fleets. Its adjusters can provide re-inspection information used to determine the reinspection results metric.

EMS is a Collision Industry EDI (Electronic Data Interchange) standard for transmitting data between two or more software programs. CIECA—the Collision Industry Electronic Commerce Association is the governing body that created the standard. CCC, Michell and ADP are companies that provide collision damage estimating software databases containing parts pricing information and repair procedure labor time studies.

Body shop estimating data is obtained from collision centers'profiles and estimating systems over the internet and is used to determine the following metrics: weighted repair severity, percent supplemented, number of supplements, ratio of parts as percentage of sales, alternative parts percentage, and ratio of repairs to replacements.

Nugen IT maintains a central database for housing all of the Collision Center performance data. It also provides a software product called Enterprise workflow which is used to determine the PCI and Closed Claim Compliance metrics. The NSS Database houses the information that the Performance Rating Reports are run off of.

Billing information is used to bill customers for the services provided to customers of the Performance Rating system. RO Data refers to Repair Order data and is synonymous with estimate data. This Data is harvested from the repair shop and put into the databases for reporting purposes and Performance Rating Calculation purposes.

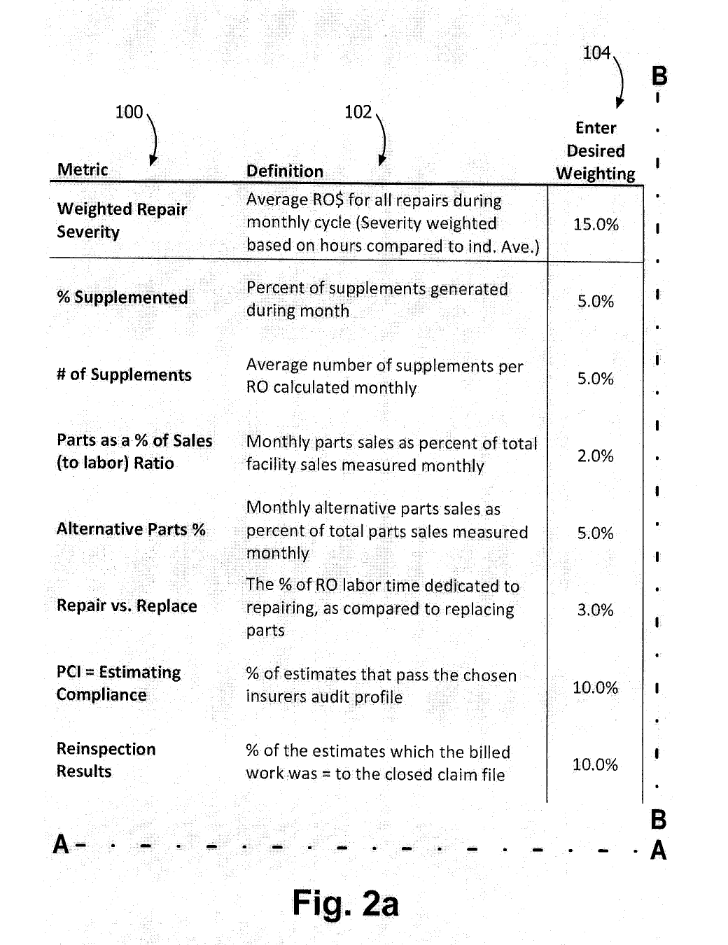

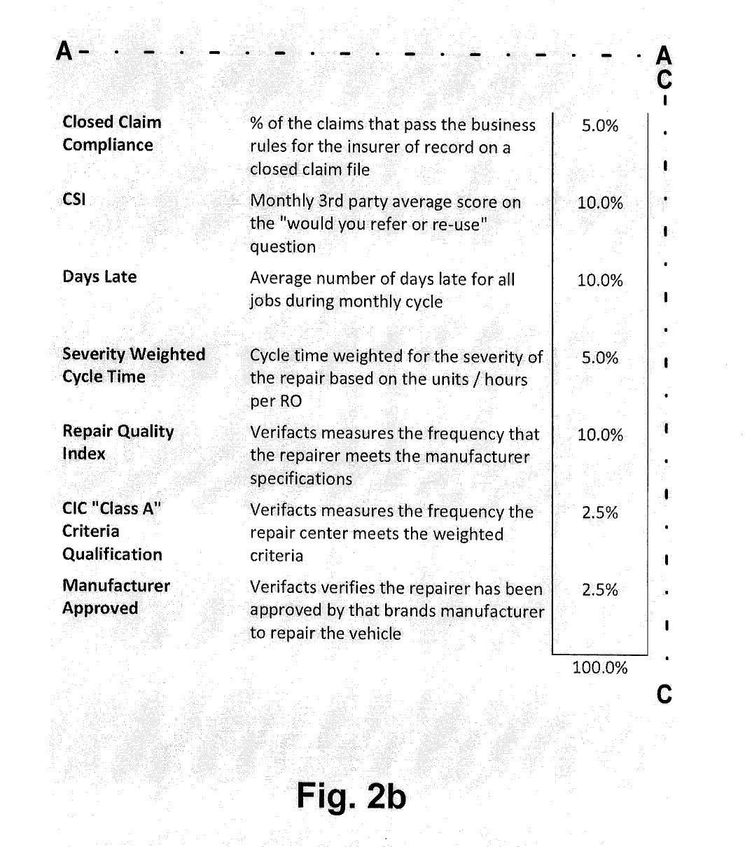

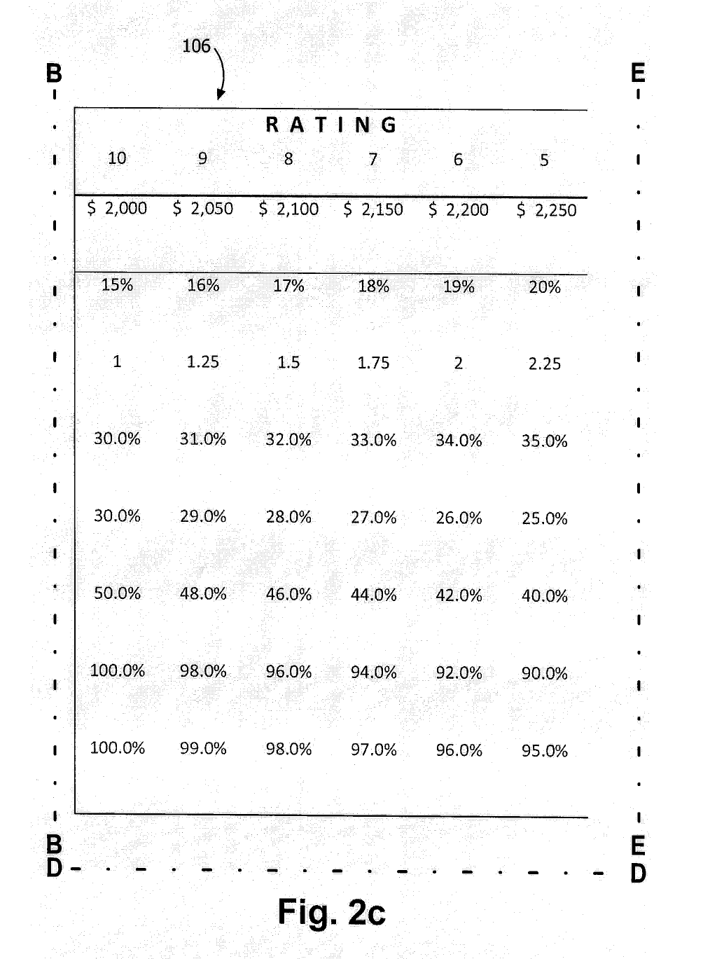

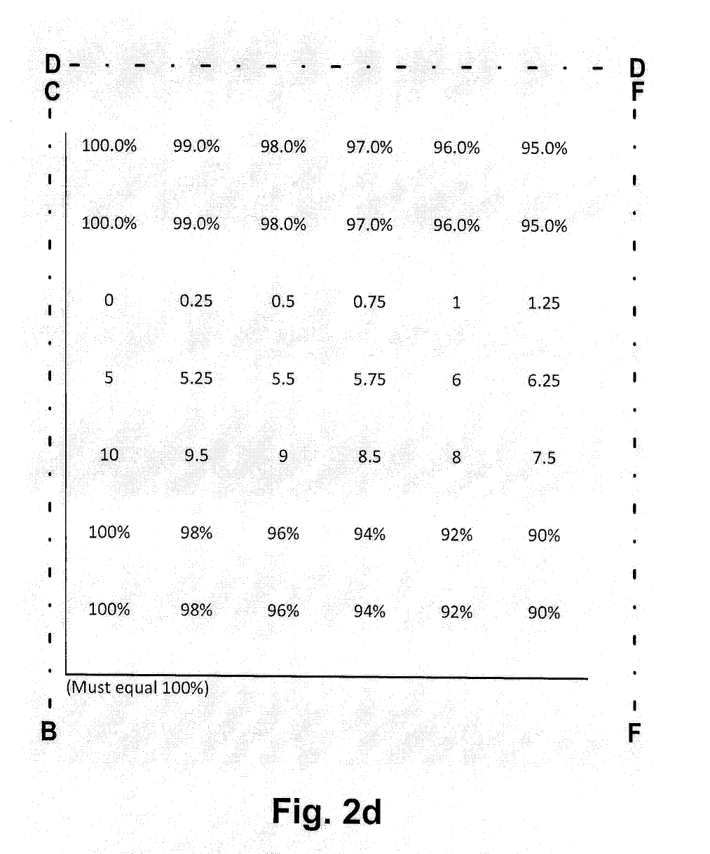

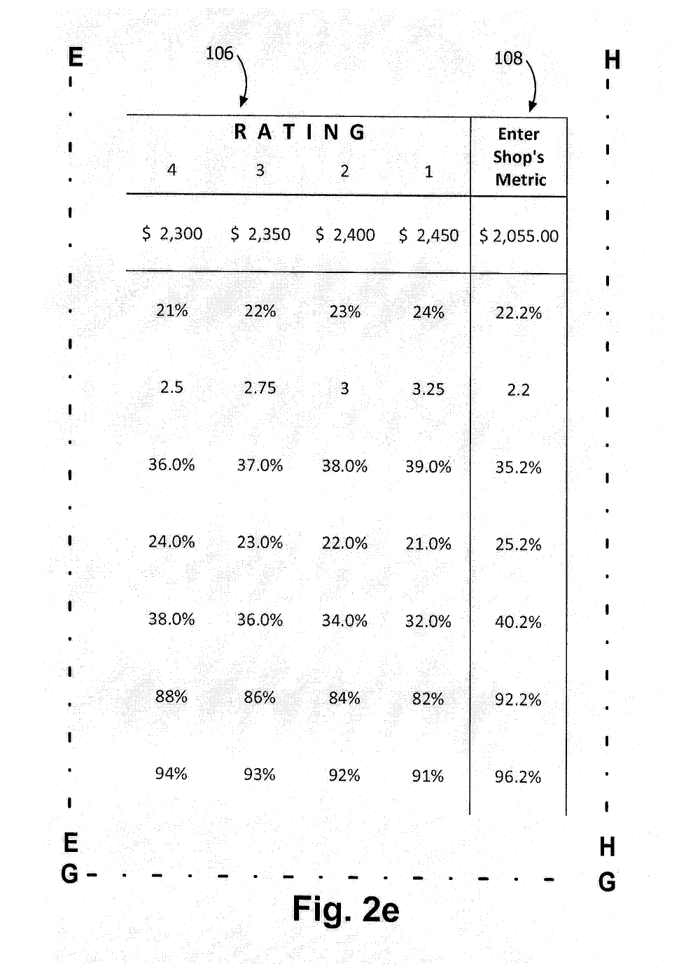

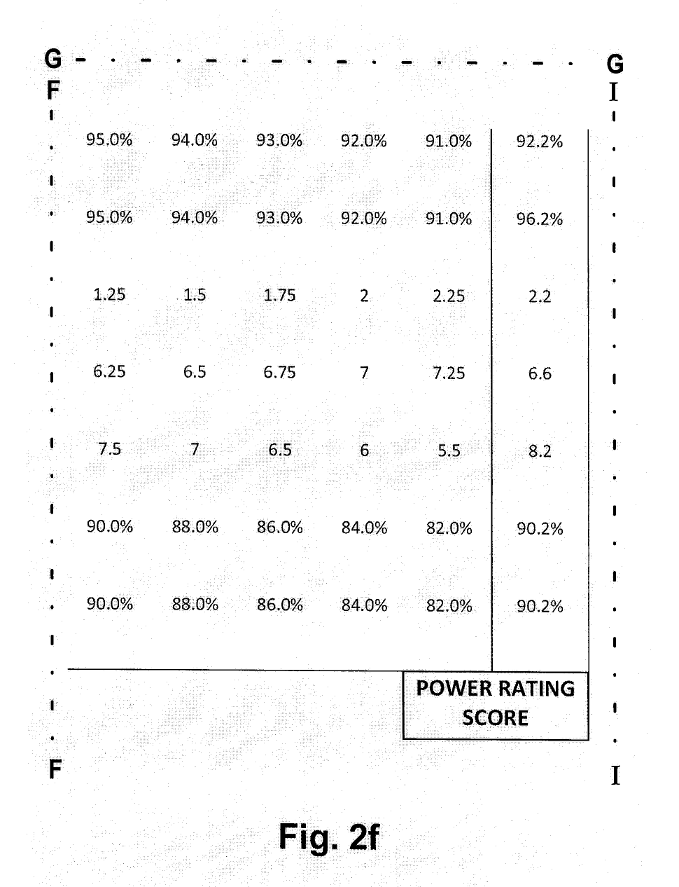

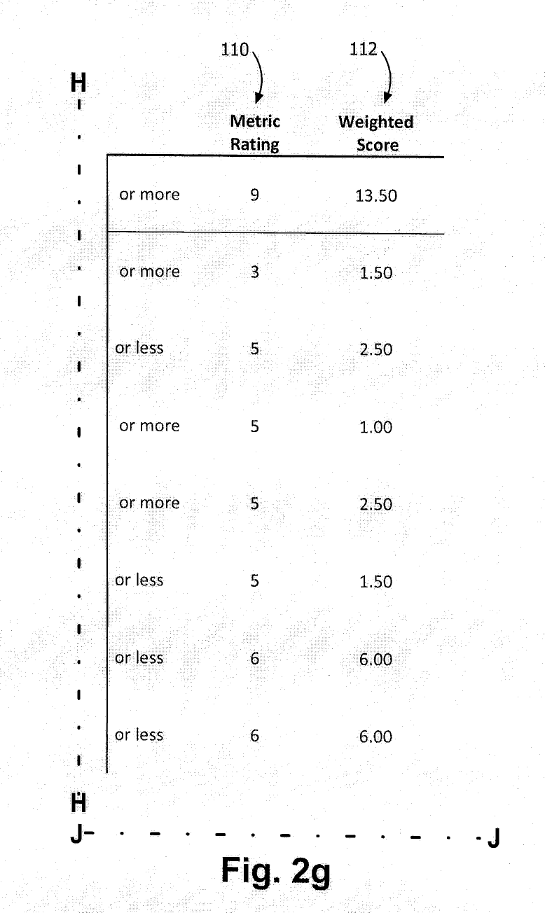

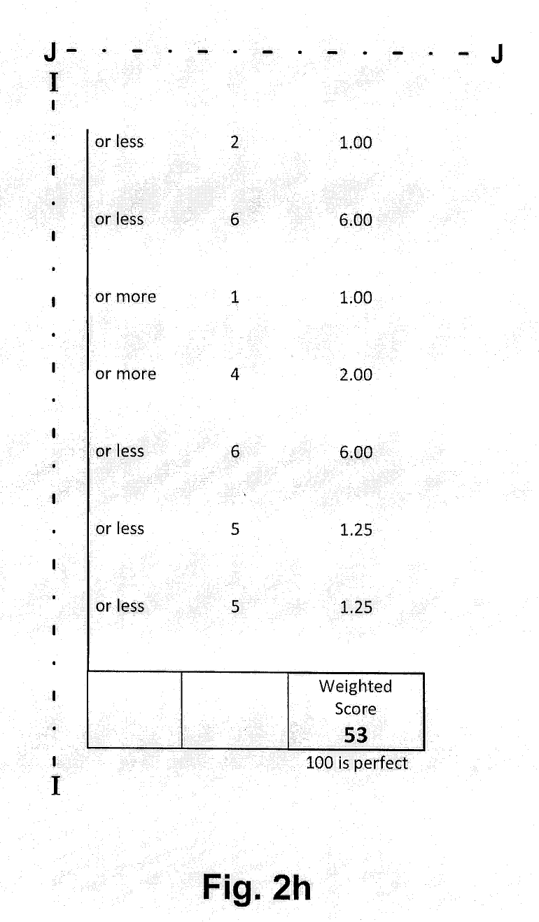

FIG. 2 shows an example of a report that is available to a repair shop being evaluated, which displays the performance rating screen for the selected collision repair shop. The metric column 100 lists the performance metrics used for determining the performance rating of the subject repair shop. The definition column 102 lists the definitions for each of the metrics listed in the metric column 100.

The desired weighting column 104 shows the desired weighting for each metric. The desired weighting was entered as a percentage of all desired weightings, which total to 100%.

The rating scale column 106 consists of ten sub-columns, with each of the ten sub-columns representing a level of the rating scale. The rating scale is a graduated scale ranging from 1 to 10, with 1 being the least desired value for each metric and 10 being the most desired value for each metric. The rating scale goes up in increments of one, which represent incremental increases in the desired value for each metric. The rating scale for each metric was determined by statistical analysis of the performance data obtained from comparative repair shops to the shop being evaluated, as discussed above.

The shop's metric column 108 lists the performance data (metric value) for the subject repair shop for each metric listed in the metric column 100. The metric rating column 110 lists the unweighted metric rating for each metric listed in column 100. The unweighted metric rating for each metric was determined by comparing the corresponding metric value for the subject shop to the corresponding metric values contained in the rating scale column 106. The unweighted metric rating is the rating scale number (i.e., 1-10) corresponding to the sub-column having a metric value closest to the shop's metric value.

The weighted score column 112 lists the weighted score for each metric listed in column 100. The weighted score was calculated by multiplying the corresponding desired weighting (from the desired weighting column 104) by the corresponding metric rating (from the metric rating column 110) divided by 10. The sum of all the weighted scores (in the weighted score column 112) is the overall weighted score for the subject repair shop. The maximum or perfect overall weighted score is 100.

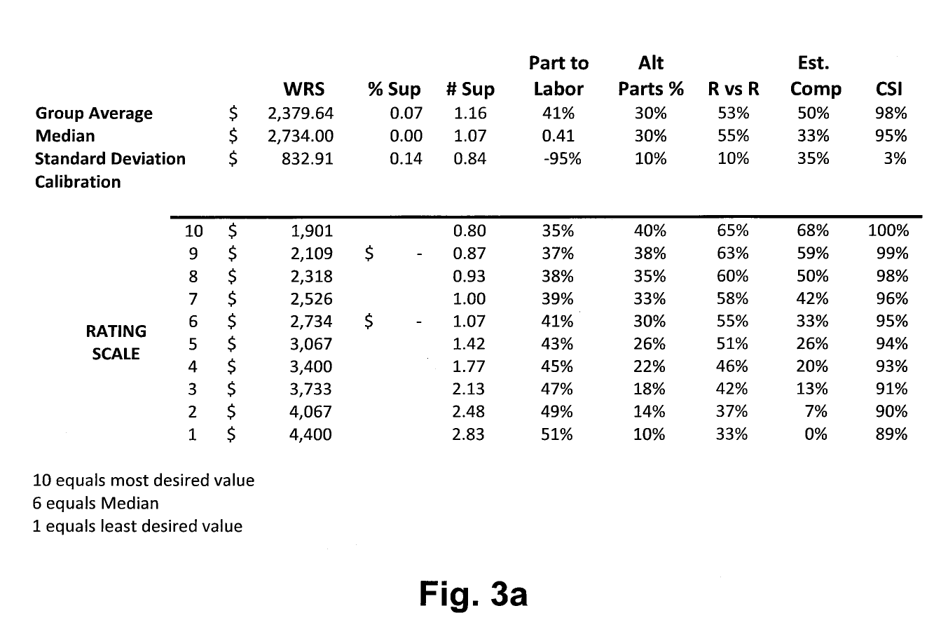

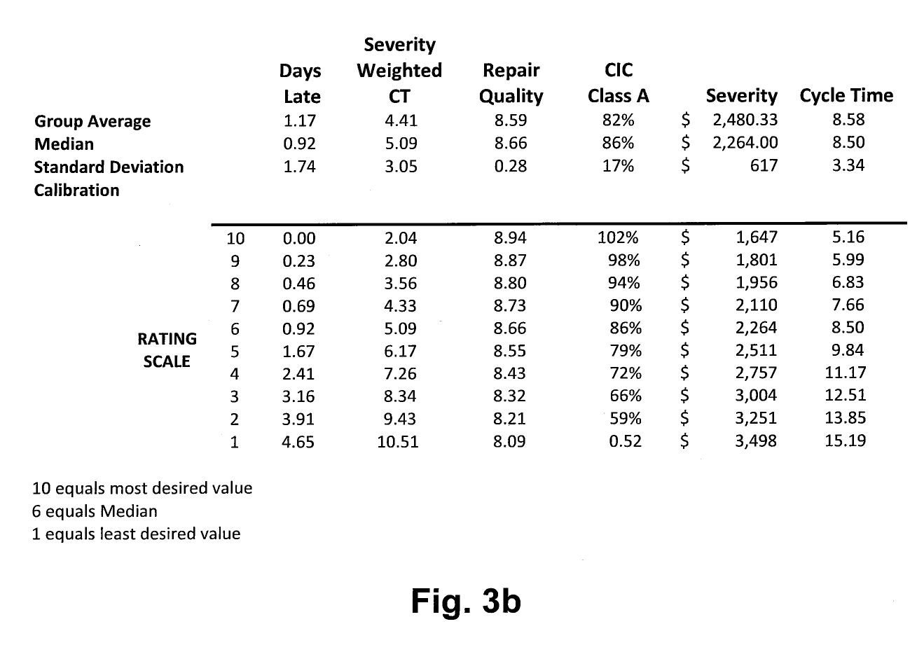

FIGS. 3a and 3b show a chart illustrating an example of how rating scales were determined for various metrics for performance rating of a collision repair shop. The individual metrics are identified as headings across the top of each column of data. For each metric the calculated Average, Median and Standard Deviation of the performance data obtained from comparative repair shops is shown in the top three rows, respectively. The rating scale for each metric is based on a graduated scale from 1 to 10, with 1 corresponding to the least desired value in the range of values and 10 corresponding to the most desired value in the range of values. The value corresponding to 6 on the rating scale was set equal to the calculated median for each metric. The value corresponding to 1 was set at 2 standard deviations below the median and the value corresponding to 10 was set at 1 standard deviation above the median for the metrics where the performance data resembled a normal distribution. These metrics included Weighted Repair Severity (WRS), Ratio of Parts to Sales (Part to Labor), Alternative Parts, Ratio of Repairs to Replacements (R vs R), PCI (Est. Comp), Repair Quality, CIC Class A, Severity Weighted Cycle Time and Cycle Time. Of these, the values corresponding to 10 and 1, respectively, for Part to Labor and R vs R, appear to deviate from the calculations due to rounding off, and the value corresponding to 1 for Est. Comp was set at 0% to reflect an actual performance limit.

For metrics where the performance data did not resemble a normal distribution, the data for the lowest and highest 10% of the repair shops for each metric were disregarded. The value corresponding to 1 was set at the actual lowest recorded value of the remaining data population and the value corresponding to 10 was set at the highest recorded value of the remaining data population. These metrics included Number Supplemented (#Sup), Days Late and Severity Weighted Cycle Time.

For CSI, the value corresponding to 6 on the rating scale was set equal to the calculated median. The value corresponding to 1 was set at 2 standard deviations below the median, since the performance data below the median resembled a normal distribution. However, since the performance data above the median did not resemble a normal distribution, the highest 10% of the repair shops for the CSI metric were disregarded and the value corresponding to 10 was set at the highest recorded value of the remaining data population, i.e., 100%.

A rating scale for % Supplemented (% Sup) was not determined because of insufficient data. The values corresponding to the remaining rating scale graduations for each metric were set by evenly dividing the values between 1 and 6 (for the graduations 2-5) and between 6 and 10 (for the graduations 7-9), with some apparent deviation due to rounding off.

What is claimed is:

1. A method for performance rating of a business entity using a server computer and one or more remote client computers linked to said server computer by a communication network, said method comprising:
(a) defining a plurality of performance metrics related to performance of said business entity;
(b) defining desired weighting for each performance metric of the plurality of performance metrics;
(c) obtaining performance data for said business entity for each performance metric of the plurality of performance metrics;
(d) defining a rating scale for each performance metric, wherein the rating scale for at least one performance metric is determined based on statistical data derived from a plurality of comparative business entities for said at least one performance metric;
(e) comparing said performance data for said business entity to said rating scale for each performance metric; and
(f) deducing a performance rating for said business entity on the basis of the comparison between said performance data from said business entity and said rating scale, and said desired weighting, for each performance metric.

2. A method according to claim 1, wherein step (f) comprises the steps of:
(g) determining an unweighted metric rating for each performance metric on the basis of the comparison between said performance data from said business entity and said rating scale for each performance metric;
(h) calculating a weighted score for each performance metric on the basis of said desired weighting and said unweighted metric rating; and
(i) calculating said performance rating for said business entity on the basis of all weighted scores.

3. A method according to claim 2, wherein said business entity is a service business entity.

4. A method according to claim 3, wherein said service business entity is a collision repair shop.

5. A method according to claim 4, wherein said plurality of performance metrics includes at least two metrics selected from the group consisting of weighted repair severity, percent supplemented, number of supplements, ratio of parts as percentage of sales, alternative parts percentage, ratio of repairs to replacements, PCI (percent of estimates passing chosen insurer's audit profile), reinspection results, closed claim compliance, CSI (consumer survey information), days late, severity weighted cycle time, repair quality index, CIC “Class A” criteria qualification and manufacturer approved repair.

6. A method according to claim 4, wherein said client is selected from the group consisting of said business entity, another collision repair shop, consumer, insurance agent, insurance claims personnel, auto dealership, fleet administrator and other stakeholder involved in the collision repair process.

7. A method according to claim 6, wherein said client is said business entity.

8. A method according to claim 2, wherein said rating scale is determined based on statistical data derived from a plurality of comparative business entities for each performance metric.

9. A method according to claim 8, wherein outlying, extraneous or extrinsic data points are excluded from said statistical data prior to making said determination.

10. A method according to claim 8, wherein said rating scale is a graduated scale ranging from 1 to 10 proportionate with a range of values for each metric, ranging from a least desired value to a most desired value, wherein said range of values is based on statistical analysis of performance data obtained from said plurality of comparative business entities.

11. A method according to claim 10, wherein said values corresponding to 1 and 10 on the rating scale are calculated as functions of the standard deviation of the performance data obtained from said plurality of comparative business entities, with the proviso that if said calculated values fall outside of an actual performance limit, then the value will be set to that actual performance limit.

12. A method according to claim 11, wherein the calculated value corresponding to 1 on the rating scale is equal to two standard deviations below the median value of the performance data and the calculated value corresponding to 10 on the rating scale is equal to one standard deviation above the median value.

13. A method according to claim 10, wherein said values corresponding to 1 and 10 on the rating scale are calculated as functions of a percentage of difference from selected data points from said performance data or functions of said performance data from a percentage of said comparative business entities.

14. A method according to claim 13, wherein the values for the highest and lowest 10% of said comparative business entities are disregarded and the value corresponding to 1 on the rating scale is equal to the least desired value from the remaining business entities and the value corresponding to 10 on the rating scale is equal to the most desired value from the remaining business entities.

15. A method according to claim 10, wherein said values corresponding to 1 and 10 on the rating scale are each calculated by different methods selected from the group consisting of a function of the standard deviation of the performance data, a function of a percentage of difference from selected data points from said performance data and a function of said performance data from a percentage of said comparative business entities, with the proviso that if a calculated value falls outside of an actual performance limit, then the value will be set to that actual performance limit.

16. A method according to claim 10, wherein said plurality of comparative business entities includes said business entity.

17. A method according to claim 10, wherein said step of obtaining performance data from said plurality of comparative business comprises uploading said performance data from one or more remote comparative business computers linked to said server computer by a communication network.

18. A method according to claim 10, wherein said step of obtaining performance data from said plurality of business entities comprises uploading said performance data from one or more remote third party verification computers linked to said server computer by a communication network.

19. A method according to claim 10, wherein said desired weighting is a number representing a percentage of the total desired weighting for all metrics of said plurality of performance metrics, with the proviso that the sum of all desired weightings is 100.

20. A method according to claim 10, wherein said step (g) of determining an unweighted metric rating comprises identifying where said performance data from said business entity falls on said rating scale relative to said range of values derived from said plurality of comparative business entities.

21. A method according to claim 20, wherein said step (h) of calculating said weighted score comprises multiplying said desired weighting by said unweighted metric rating divided by 10.

22. A method according to claim 21, wherein said step (i) of calculating said performance rating comprises determining the sum total of all weighted scores.

23. A method according to claim 2, wherein said step (c) of obtaining performance data for said business entity comprises uploading said performance data on a periodic basis from one or more remote business entity computers linked to said server computer by a communication network.

24. A method according to claim 2, wherein said step (c) of obtaining performance data for said business entity comprises uploading said performance data on a periodic basis from one or more remote third party verification computers linked to said server computer by a communication network.

25. A method according to claim 1, wherein said business entity is certified prior to receiving said performance rating.

26. A computer implemented system for performance rating of a business entity, comprising: a processor for receiving and transmitting data; and a memory coupled to said processor, the memory having stored therein sequences of instructions which, when executed by the processor, cause the processor to perform the steps of:
(a) defining a plurality of performance metrics related to performance of said business entity;
(b) defining desired weighting for each performance metric of the plurality of performance metrics;
(c) obtaining performance data for said business entity for each performance metric of the plurality of performance metrics;
(d) defining a rating scale for each performance metric, wherein the rating scale for at least one performance metric is determined based on statistical data derived from a plurality of comparative business entities for said at least one performance metric;
(e) comparing said performance data for said business entity to said rating scale for each performance metric; and
(f) deducing a performance rating for said business entity on the basis of the comparison between said performance data from said business entity and said rating scale, and said desired weighting, for each performance metric.

27. A computer implemented system according to claim 26, wherein said business entity is a collision repair shop and said plurality of performance metrics includes at least two metrics selected from the group consisting of weighted repair severity, percent supplemented, number of supplements, ratio of parts as percentage of sales, alternative parts percentage, ratio of repairs to replacements, PCI (percent of estimates passing chosen insurer's audit profile), reinspection results, closed claim compliance, CSI (consumer survey information), days late, severity weighted cycle time, repair quality index, CIC “Class A” criteria qualification and manufacturer approved repair.

28. A computer-readable medium whose contents cause a computer system to determine a performance rating of a business entity by performing the steps of:
(a) defining a plurality of performance metrics related to performance of said business entity;
(b) defining desired weighting for each performance metric of the plurality of performance metrics;
(c) obtaining performance data for said business entity for each performance metric of the plurality of performance metrics;
(d) defining a rating scale for each performance metric, wherein the rating scale for at least one performance metric is determined based on statistical data derived from a plurality of comparative business entities for said at least one performance metric;
(e) comparing said performance data for said business entity to said rating scale for each performance metric; and
(f) deducing a performance rating for said business entity on the basis of the comparison between said performance data from said business entity and said rating scale, and said desired weighting, for each performance metric.

29. A computer-readable medium according to claim 28, wherein said business entity is a collision repair shop and said plurality of performance metrics includes at least two metrics selected from the group consisting of weighted repair severity, percent supplemented, number of supplements, ratio of parts as percentage of sales, alternative parts percentage, ratio of repairs to replacements, PCI (percent of estimates passing chosen insurer's audit profile), reinspection results, closed claim compliance, CSI (consumer survey information), days late, severity weighted cycle time, repair quality index, CIC “Class A” criteria qualification and manufacturer approved repair.
